(19) United States
(12) Patent Application Publication
(10) Pub. No.: US 2025/0201935 A1
(43) Pub. Date: Jun. 19, 2025

(54) TEST CELL ASSEMBLY INCLUDING A REFERENCE ELECTRODE

(71) Applicants: Hyundai Motor Company, Seoul (KR); Kia Corporation, Seoul (KR); Institute for Reseach & Industry Cooperation Pusan National University, Busan (KR)

(72) Inventors: Chung Bum Lim, Suwon-si (KR); Hong-Seok Min, Yongin-si (KR); Sung Woo Noh, Seoul (KR); Je Sik Park, Seoul (KR); Jeong Hyun Seo, Daejeon (KR); Im Sul Seo, Cheongju-si (KR); Joo Young Lee, Pyeongtaek-si (KR); Ju Yeong Seong, Seongnam-si (KR); Yong Seok Lee, Suwon-si (KR); Yu Jeong Min, Busan (KR); So Young Joo, Busan (KR); Ga Eun Lee, Busan (KR); Heon-Cheol Shin, Busan (KR)

(21) Appl. No.: 18/671,374

(22) Filed: May 22, 2024

(30) Foreign Application Priority Data
Dec. 15, 2023 (KR) 10-2023-0183209

(51) Int. Cl. H01M 10/42; G01N 27/30; H01M 10/04

(52) U.S. Cl. CPC H01M 10/4214; G01N 27/301; H01M 10/0468; H01M 2300/0065

(57) ABSTRACT

A test cell assembly can include a reference electrode. The reference electrode can be connected to the outside of an all-solid-state battery and two or more reference electrodes can be provided so as to be rotatable and linearly movable, so it is possible to switch electrode modes and replace a deteriorated reference electrode without disassembling the all-solid-state battery.

### CROSS-REFERENCE TO RELATED APPLICATIONS

The present application claims priority to Korean Patent Application No. 10-2023-0183209, filed Dec. 15, 2023, the entire contents of which is incorporated herein for all purposes by this reference.

### TECHNICAL FIELD

The present disclosure relates to a test cell assembly including a changeable reference electrode.

### BACKGROUND

Lithium-ion batteries have presented one of the best performances among existing batteries. Lithium-ion batteries have undergone a lot of research and are currently widely used in the market. However, lithium-ion batteries structurally have a risk of ignition and explosion. For example, oxygen is contained in a cathode active material, and a liquid electrolyte acts as fuel at high temperature and thus catches on fire.

Specifically, when events such as formation of lithium dendrites, separator defects, overcharging, and impact on battery cells occur, a large amount of current flows. This causes dissolution of a separator, exposure of an anode, and a further increase in battery temperatures, leading to decomposition of a cathode material and release of oxygen. Eventually, oxygen, heat, and fuel react with each other, causing the liquid electrolyte to burn.

Accordingly, research is being actively conducted on next-generation batteries with higher energy density and stability than lithium-ion batteries.

Among them, the most representative one is an all-solid-state battery. All-solid-state batteries are batteries in which an electrolyte is solid. Therefore, all materials in the battery exist in solid form.

Because the all-solid-state battery uses a solid electrolyte that does not evaporate due to temperature changes or leak due to external shock, the stability thereof is excellent. Further, the all-solid-state battery has no risk of swelling and can operate normally even in extreme external environments with high heat and pressure.

Moreover, unlike a lithium-ion battery that uses a liquid electrolyte, the all-solid-state battery does not undergo a phenomenon called “desolvation” in which lithium ions are separated from a solvent during charging and discharging. The charging and discharging reaction relates directly to the diffusion reaction of lithium ions in the solid, thus achieving high output.

Also, the all-solid-state battery has another advantage of having a wide operating temperature range. Compared to conventional liquid electrolytes, the all-solid-state battery can secure stable performance in a wide temperature range. In particular, the all-solid-state battery can be expected to have high ionic conductivity at low temperatures. One of the problems of electric vehicles is that in winter, the performance of the battery deteriorates, reducing the mileage. When the era of all-solid-state batteries comes, anxiety with regard to low-temperature environments will be overcome.

Meanwhile, performance related to the above advantages of all-solid-state batteries can be evaluated in terms of various items such as charge/discharge capacity, charge/discharge characteristics, high-temperature discharge characteristics, low-temperature discharge characteristics, stability, and lifespan. However, at present, there are no regulations setting forth performance standards.

In relation to this, mid-to long-term electrochemical tests are performed in the process of evaluating the durability characteristics of all-solid-state batteries, and to identify deterioration factors, it is required to separately acquire a cathode signal and an anode signal.

To separately acquire the cathode signal and the anode signal, a reference electrode can be inserted into a solid electrolyte part. However, in this case, as charging and discharging are repeated, contamination and deterioration of the reference electrode may become severe due to chemical reactions on the surface of the reference electrode. In addition, there is a problem that the all-solid-state battery is required to be disassembled in order to replace the contaminated and deteriorated reference electrode.

The foregoing is intended merely to aid in the understanding of the background of the present disclosure, and may not falls within the purview of the related art that is already publicly known, available, or in use.

### SUMMARY

The present disclosure relates to a test cell assembly including a reference electrode. Specifically, a reference electrode can be connected to the outside of an all-solid-state battery and two or more reference electrodes can be provided so as to be rotatable and linearly movable, so it can be possible to switch electrode modes and replace a deteriorated reference electrode without disassembling the all-solid-state battery.

Accordingly, some embodiments of the present disclosure can solve the above-stated problems and can improve deterioration and contamination of a reference electrode during a durability characteristic evaluation process of an all-solid-state battery by not inserting the reference electrode into a solid electrolyte part.

An embodiment of the present disclosure can provide a test cell assembly that can replace a deteriorated reference electrode without disassembling an all-solid-state battery.

The advantages of some embodiments of the present disclosure are not limited to those mentioned above. The advantages of some embodiments of the present disclosure can become apparent from the following description and can be realized by implementations and combinations thereof as set forth in the claims.

According to an embodiment of the present disclosure, a test cell assembly can include a frame having an internal space of a predetermined volume, an all-solid-state battery accommodated in the internal space, and a reference electrode structure provided on an outer lateral surface of the frame. The reference electrode structure may include: a reference electrode part acquiring electrochemical signals of the all-solid-state battery; a connection part fixed to the outer lateral surface of the frame and being in contact with the reference electrode part; a linear movement part linearly moving the reference electrode part; and a rotational movement part rotating the reference electrode part.

In an embodiment, the frame may include: a hollow body part having open upper and lower sides and having the internal space; an upper pressurizing part fitted to the upper side of the body part and pressurizing an upper portion of the all-solid-state battery in a contact manner; and a lower pressurizing part fitted to the lower side of the body part and pressurizing a lower portion of the all-solid-state battery in a contact manner.

The body part may include: a seating recess recessed to a predetermined depth from an outer lateral surface of the body part; and a through-hole formed through an inner surface of the body part to communicate the internal space and the seating recess with each other.

In addition, the body part may include a filling member filled in the through-hole. The filling member may include a solid electrolyte, and the filling member may form a movement passage for lithium ions between the all-solid-state battery and the reference electrode structure.

In an embodiment, the connection part may be inserted into the seating recess and have a cylindrical shape with a first surface in contact with the through-hole, and the reference electrode part may include: a cylindrical fixing member being in contact with a second surface of the connection part and rotatable about a lengthwise central axis thereof; two or more insertion passages formed through the fixing member from a first end to a second end thereof; and two or more reference electrodes inserted into the insertion passages.

In an embodiment, the connection part may include: a cylindrical plate; a connection hole formed through the plate from a first surface to a second surface thereof; and an insulating hole formed through the plate from the first surface to the second surface thereof at a position spaced apart from the connection hole by a predetermined distance. The connection hole may be filled with a solid electrolyte, and the insulating hole may be filled with an insulating material.

In one embodiment, the two or more insertion passages may be arranged to be rotationally symmetrical about the central axis.

In an embodiment, the reference electrodes may be formed by coating a noble metal on a wire, where the wire includes tungsten (W), aluminum (Al), nickel (Ni), stainless steel (SUS), or a combination thereof, where the noble metal includes gold (Au), silver (Ag), platinum (Pt), or a combination thereof.

In an embodiment, the test cell assembly may be operated in a three-electrode mode in which any one of the two or more reference electrodes is in contact with the connection hole, or a two-electrode mode in which all the two or more reference electrodes are in contact with the plate except for the connection hole and the insulating hole.

In an embodiment, the test cell assembly may be operated in a three-electrode mode in which a movement passage for lithium ions is formed between the all-solid-state battery and the reference electrode structure, or a two-electrode mode in which a movement passage for lithium ions is not formed between the all-solid-state battery and the reference electrode structure.

In an embodiment, the test cell assembly may be switched from the three-electrode mode to the two-electrode mode or from the two-electrode mode to the three-electrode mode, and switching between the electrode modes may be performed without disassembling the all-solid-state battery.

In an embodiment, the linear movement part may include: a first moving member provided along an outer peripheral surface of the fixing member; a second moving member connected to the first moving member; and a first driving member providing a driving force to the second moving member. The first moving member may be connected to the fixing member so as to be moved linearly together with the fixing member, and the second moving member may linearly move the first moving member in a lengthwise direction of the fixing member by receiving the driving force from the first driving member.

In addition, the linear movement part may include a rod-shaped first shaft. The first shaft may have a first end connected to the second moving member and a second end connected to the first driving member and transmit the driving force of the first driving member to the second moving member.

For example, the first moving member may include a worm gear provided with at least one thread, and the second moving member may include a worm wheel provided with two or more teeth to be engaged with the thread.

In an embodiment, the linear movement part may include at least one first ball plunger formed on an inner peripheral surface of the first moving member, and the reference electrode part may include two or more first insertion concave portions recessed and spaced apart at a predetermined angle along a circumference of the outer peripheral surface of the fixing member. The first ball plunger may include: a first plunger body having an internal region of a predetermined volume and having an opening open in one direction; a first spring located in the internal region; and a first plunger ball located in the opening of the first plunger body and movable in a vertical direction by the first spring. The first plunger ball may be inserted into the first insertion concave portion.

In an embodiment, the rotational movement part may include: a first rotating member provided along an outer peripheral surface of the fixing member; a second rotating member connected to the first rotating member; and a second rotating member providing a driving force to the second rotating member. The first rotating member may be connected to the fixing member so as to be rotated together with the fixing member, and the second rotating member may rotate the first rotating member about the central axis by receiving the driving force from the second driving member.

For example, the first rotating member may include a first bevel gear, and the second rotating member may include a second bevel gear. The first bevel gear and the second bevel gear may be connected to mesh with each other.

In an embodiment, in the rotational movement part may include a rod-shaped second shaft. The second shaft may have a first end connected to the second rotating member and a second end connected to the second driving member and transmit the driving force of the second driving member to the second rotating member.

In an embodiment, the rotational movement part may include at least one second ball plunger formed on an inner peripheral surface of the first rotating member, and the reference electrode part may include a second insertion concave portion recessed on the outer peripheral surface of the fixing member to extend along the lengthwise direction thereof. The second ball plunger may include: a second plunger body having an internal region of a predetermined volume and having an opening open in one direction; a second spring located in the internal region; and a second plunger ball located in the opening of the second plunger body and movable in a vertical direction by the second spring. The second plunger ball may be inserted into the second insertion concave portion.

According to a test cell assembly embodiment of the present disclosure, because the reference electrode part is not inserted into the solid electrolyte of the all-solid-state battery, but is connected to the outer lateral surface of the all-solid-state battery, contamination and deterioration of a reference electrode can be suppressed. In addition, in an embodiment, the reference electrode part can block the movement passage of lithium ions in the solid electrolyte, thereby preventing the performance of the all-solid-state battery from degrading.

In an embodiment, by linearly moving or rotating the reference electrode part, a contaminated and deteriorated reference electrode can be replaced or electrode modes can be switched without disassembling the all-solid-state battery.

The advantages of the present disclosure are not limited to those mentioned above.

The advantages of the present disclosure can be understood to include all effects and advantages that can be inferred from the following description.

### BRIEF DESCRIPTION OF THE DRAWINGS

The above and other features, and other advantages of the present disclosure can be more clearly understood from the following detailed description when taken in conjunction with the accompanying drawings, in which:

FIG. 1 is a schematic view illustrating a test cell assembly according to an embodiment of the present disclosure;

FIG. 2 is a schematic view illustrating a frame and an all-solid-state battery of the test cell assembly according to an embodiment of the present disclosure;

FIG. 3 is a schematic view illustrating a reference electrode structure of the test cell assembly according to an embodiment of the present disclosure;

FIG. 4 is a sectional view illustrating a reference electrode part according an embodiment of to the present disclosure;

FIG. 5 is a sectional view illustrating a connection part according to an embodiment of the present disclosure;

FIG. 6A is a perspective view illustrating the connection relationship between the connection part and the reference electrode part when the test cell assembly according to an embodiment of the present disclosure is operated in a three-electrode mode;

FIG. 6B is a perspective view illustrating the connection relationship between the connection part and the reference electrode part when the test cell assembly according to an embodiment of the present disclosure is operated in a two-electrode mode;

FIGS. 7A to 7E are schematic views sequentially illustrating the process of replacing a reference electrode in the test cell assembly according to an embodiment of the present disclosure without disassembling the all-solid-state battery;

FIG. 8 is a schematic view illustrating a ball plunger according to an embodiment of the present disclosure;

FIG. 9 is a perspective view illustrating the reference electrode part in which a first insertion concave portion and a second insertion concave portion are formed according to an embodiment of the present disclosure;

FIG. 10 is a sectional view illustrating the engagement of a first ball plunger and the first insertion concave portion according to an embodiment of the present disclosure;

FIG. 11 is a sectional view illustrating the engagement of a second ball plunger and the second insertion concave portion according to an embodiment of the present disclosure; and

FIGS. 12A to 12E are schematic views illustrating the process of operating the first ball plunger and the first insertion concave portion or the second ball plunger and the second insertion concave portion in the process of replacing the reference electrode according to an embodiment of the present disclosure.

### DETAILED DESCRIPTION OF ILLUSTRATIVE EMBODIMENTS

The above and other features and advantages of the present disclosure will be clearly understood from the more particular description of example embodiments of the present disclosure. The present disclosure may, however, be embodied in different forms and should not be construed as limited to the example embodiments set forth herein. Rather, these example embodiments are provided so that this disclosure is thorough and complete and fully conveys the present disclosure to those skilled in the art.

Throughout the drawings, same reference numerals can refer to same or like parts. Also, in the drawings, the sizes of structures may be exaggerated for clarity of illustration. It can be understood that, although the terms “first”, “second”, etc., may be used herein to describe various elements, and such elements are not necessarily limited by such terms. Such terms can be merely used to distinguish one element from another element. For instance, a first element discussed below can be termed a second element without departing from the teachings of the present disclosure. Similarly, the second element can also be termed the first element. As used herein, singular forms “a”, “an”, and “the” are intended to include the plural forms as well, unless the context clearly indicates otherwise.

It can be further understood that the terms “comprise”, “include”, “have”, etc., when used in this specification, specify the presence of stated features, integers, steps, operations, elements, components, and/or combinations thereof but do not preclude the presence or addition of one or more other features, integers, steps, operations, elements, components, and/or combinations thereof. Further, an expression that an element such as a layer, film, region, substrate or plate is placed “on” or “above” another element indicates not only a case where the element is placed “directly on” or “just above” the other element but also a case where a further element is interposed between the element and the other element. On the contrary, an expression that an element such as a layer, film, region, substrate or plate is placed “beneath” or “below” another element indicates not only a case where the element is placed “directly beneath” or “just below” the other element but also a case where a further element is interposed between the element and the other element.

Unless context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures among other things. For this reason, it can be understood that, in all cases, the term “about” modifies all the numbers, figures and/or expressions. In addition, when numerical ranges are disclosed in the description, these numerical ranges are continuous and include all numbers from the minimum to the maximum including the maximum within the ranges unless otherwise defined. Furthermore, when the range is referred to as an integer, it includes all integers from the minimum to the maximum including the maximum within the range, unless otherwise defined.

In the present specification, when a range is described for a variable, it can be understood that the variable includes all values including the end points described within the stated range. For example, the range of “5 to 10” can be understood to include any subranges, such as 6 to 10, 7 to 10, 6 to 9, 7 to 9, and the like, as well as individual values of 5, 6, 7, 8, 9 and 10, and can also be understood to include any value between the valid integers within the stated range, such as 5.5, 6.5, 7.5, 5.5 to 8.5, 6.5 to 9, and the like. Also, for example, the range of “10% to 30%” can be understood to include any subranges, such as 10% to 15%, 12% to 18%, 20% to 30%, etc., as well as all integers including values of 10%, 11%, 12%, 13% and the like and up to 30%, and can also be understood to include any value between the valid integers within the stated range, such as 10.5%, 15.5%, 25.5%, and the like.

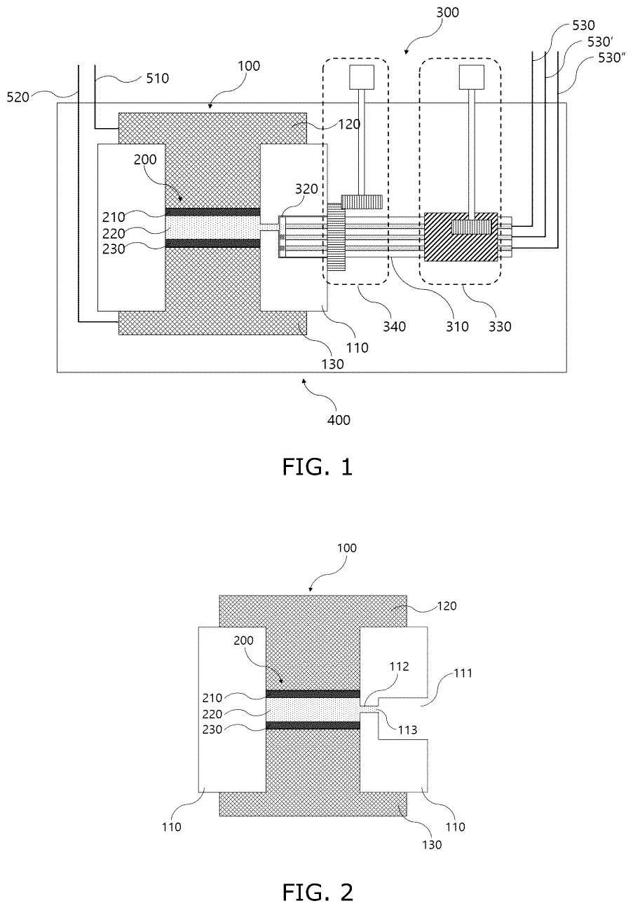

FIG. 1 is a view illustrating a test cell assembly according to an embodiment of the present disclosure. Referring to FIG. 1, the test cell assembly according to an embodiment of the present disclosure may include a frame 100 having an internal space of a predetermined volume, an all-solid-state battery 200 accommodated in the internal space, and a reference electrode structure 300 provided on an outer lateral surface of the frame 100.

The all-solid-state battery 200 may include a cathode part 210 including a cathode current collector and a cathode active material layer, wherein the cathode active material layer can include a cathode active material; a solid electrolyte part 220 can contain a solid electrolyte; and an anode part 230 can include an anode current collector and an anode active material layer wherein the anode active material layer can include an anode active material.

The cathode current collector can serve as a passage to transfer electrons from the outside so that an electrochemical reaction occurs in the cathode active material in the battery, or to receive electrons from the cathode active material and send them to the outside.

The cathode current collector may include an electrically conductive plate-shaped substrate. For example, the cathode current collector may include an aluminum foil. Here, the thickness of the cathode current collector is not particularly limited, but may be, for example, 1 μm to 500 μm.

The cathode active material layer may include a cathode active material, a solid electrolyte, a conductive material, a binder, and the like. The cathode active material is a compound capable of intercalation and deintercalation of lithium, and may include a rock-salt-layer-type active material such as LiCoO₂, LiMnO₂, LiNiO₂, LiVO₂, Li₁₊ₓNi_{1/3}Co_{1/3}Mn_{1/3}O₂, or the like, a spinel-type active material such as LiMn₂O₄, Li (Ni_{0.5}Mn_{1.5})O₄, or the like, an inverse-spinel-type active material such as LiNiVO₄, LiCoVO₄, or the like, an olivine-type active material such as LiFePO₄, LiMnPO₄, LiCoPO₄, LiNiPO₄, or the like, a silicon-containing active material such as Li₂FeSiO₄, Li₂MnSiO₄, or the like, a rock-salt-layer-type active material in which a portion of a transition metal is substituted with a different metal, such as LiNi_{0.8}Co_{(0.2-x)}AlₓO₂ (0<x<0.2), a spinel-type active material in which a portion of a transition metal is substituted with a different metal, such as Li₁₊ₓMn_{2-x-y}MyO₄ (M being at least one of Al, Mg, Co, Fe, Ni, and Zn, 0<x+y<2), or lithium titanate such as Li₄Ti₅O₁₂ or the like.

The solid electrolyte included in the solid electrolyte part 220 has lithium ion conductivity and may include an oxide solid electrolyte or a sulfide solid electrolyte. Here, the use of a sulfide solid electrolyte with high lithium ion conductivity is preferable. The sulfide solid electrolyte is not particularly limited, but may include Li₂S—P₂S₅, Li₂S—P₂S₅—LiI, Li₂S—P₂S₅—LiCl, Li₂S—P₂S₅—LiBr, Li₂S—P₂S₅-Li₂O, Li₂S—P₂S₅—Li₂O-LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂-P₂S₅—LiI, Li₂S—B₂S₃, Li₂S—P₂S₅—ZmSn (in which m and n are positive numbers, and Z is any one of Ge, Zn, and Ga), Li₂S—GeS₂, Li₂S—SiS₂—Li₃PO₄, Li₂S—SiS₂—LiₓMO_{y} (in which x and y are positive numbers, and M is any one of P, Si, Ge, B, Al, Ga, and In), Li₁₀GeP₂S₁₂, or the like. The oxide solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), or the like.

The conductive material may include carbon black, conducting graphite, ethylene black, graphene, or the like.

The binder may include butadiene rubber, nitrile butadiene rubber, hydrogenated nitrile butadiene rubber, polyvinylidene difluoride (PVDF), polytetrafluoroethylene (PTFE), carboxymethylcellulose (CMC), or the like.

The anode current collector may include an electrically conductive plate-shaped substrate. For example, the anode current collector may include a material that does not react with lithium. Specifically, the anode current collector may include nickel (Ni), copper (Cu), stainless steel, or a combination thereof. The thickness of the anode current collector is not particularly limited, but may be, for example, 1 μm to 500 μm.

As the anode active material, a compound capable of reversible intercalation and deintercalation of lithium may be used. Specific examples for the anode active material can include: a carbonaceous material such as artificial graphite, natural graphite, graphitized carbon fiber, and amorphous carbon; a metallic compound alloyable with lithium such as Si, Al, Sn, Pb, Zn, Bi, In, Mg, Ga, Cd, a Si alloy, a Sn alloy, or an Al alloy; a metal oxide which may be undoped and doped with lithium such as SiO_{β} (0<β<2), SnO₂, vanadium oxide, lithium titanium oxide, and lithium vanadium oxide; or a composite including the metallic compound and the carbonaceous material such as a Si—C composite or a Sn—C composite. Here, any one thereof or a mixture of two or more thereof may be used. In addition, a metallic lithium thin film may be used as the anode active material.

The reference electrode structure 300 may include a reference electrode part 310 acquiring electrochemical signals of the all-solid-state battery 200, a connection part 320 fixed to the outer lateral surface of the frame 100 and being in contact with the reference electrode part 310, a linear movement part 330 linearly moving the reference electrode part 310, and a rotational movement part 340 rotating the reference electrode part 310.

In the test cell assembly according to an embodiment of the present disclosure, because the reference electrode part 310 is not inserted into the solid electrolyte of the all-solid-state battery 200, but is connected to the all-solid-state battery 200 through the connection part 320 fixed to the outer lateral surface of the all-solid-state battery 200, contamination and deterioration of a reference electrode can be suppressed.

Furthermore, if the reference electrode part 310 is in the all-solid-state battery 200, it may block the migration path of lithium ions, resulting in a decrease in the performance of the all-solid-state battery. Because the reference electrode part 310 according to an embodiment of the present disclosure exists outside the all-solid-state battery 200, the problem of the reference electrode part blocking the migration path of lithium ions in the solid electrolyte and reducing the performance of the all-solid-state battery can be prevented from occurring.

According to an embodiment of the present disclosure, by linearly moving or rotating the reference electrode part 310, a contaminated and deteriorated reference electrode can be replaced or electrode modes can be switched without disassembling the all-solid-state battery 200. Hereinbelow, each example configuration will be described in more detail with reference to the drawings.

FIG. 2 is a view illustrating the frame 100 and the all-solid-state battery 200 of the test cell assembly according to an embodiment of the present disclosure. Referring to FIG. 2, the frame 100 may include a hollow body part 110 having open upper and lower sides and having the internal space, an upper pressurizing part 120 fitted to the upper side of the body part 110 and pressurizing an upper part 210 of the all-solid-state battery 200 in a contact manner, and a lower pressurizing part 130 fitted to the lower side of the body part 110 and pressurizing a lower part 230 of the all-solid-state battery 200 in a contact manner.

In FIG. 2, it is illustrated that the upper pressurizing part 120 is in contact with the cathode part 210 of the all-solid-state battery 200 and the lower pressurizing part 130 is in contact with the anode part 230 of the all-solid-state battery 200, but the order thereof may be changed.

The upper pressurizing part 120 may include a first protruding member protruding to correspond to the shape of an upwardly open hollow of the body part 110, and a plate-shaped first substrate having a larger area than the upwardly open hollow of the body part 110. Because the first substrate has a larger area than the hollow, it can function as a kind of stopper when the upper pressurizing part 120 and the body part 110 are coupled to each other.

In addition, the upper pressurizing part 120 may be made of a conductive material so that the upper pressurizing part 120 can function as a current collector for the cathode part 210.

Meanwhile, the lower pressurizing part 130 may include a second protruding member protruding to correspond to the shape of a downwardly open hollow of the body part 110, and a plate-shaped second substrate having a larger area than the downwardly open hollow of the body part 110. Because the second substrate has a larger area than the hollow, it can function as a kind of stopper when the lower pressurizing part 130 and the body part 110 are coupled to each other.

In addition, the lower pressurizing part 130 may be made of a conductive material so that the lower pressurizing part 130 can function as a current collector for the anode part 230.

Meanwhile, the body part 110 may include a seating recess 111 recessed from the outer lateral surface of the body part 110 to a predetermined depth, and a through-hole 112 formed through an inner surface of the body part 110 to communicate the internal space and the seating recess 111 with each other. In addition, the body part 110 may include a filling member 113 filled in the through-hole 112. The filling member 113 may include a solid electrolyte.

The filling member 113 filled in the through-hole 112 can serve to connect the all-solid-state battery 200 and the reference electrode structure 300 to each other. Specifically, the filling member 113 may form a movement passage for lithium ions between the all-solid-state battery 200 and the reference electrode structure 300. The solid electrolyte included in the filling member 113 may be the same as the solid electrolyte included in the solid electrolyte part 220 of the all-solid-state battery 200.

The seating recess 111 may provide a space into which the connection part 320 and/or the reference electrode part 310 is inserted.

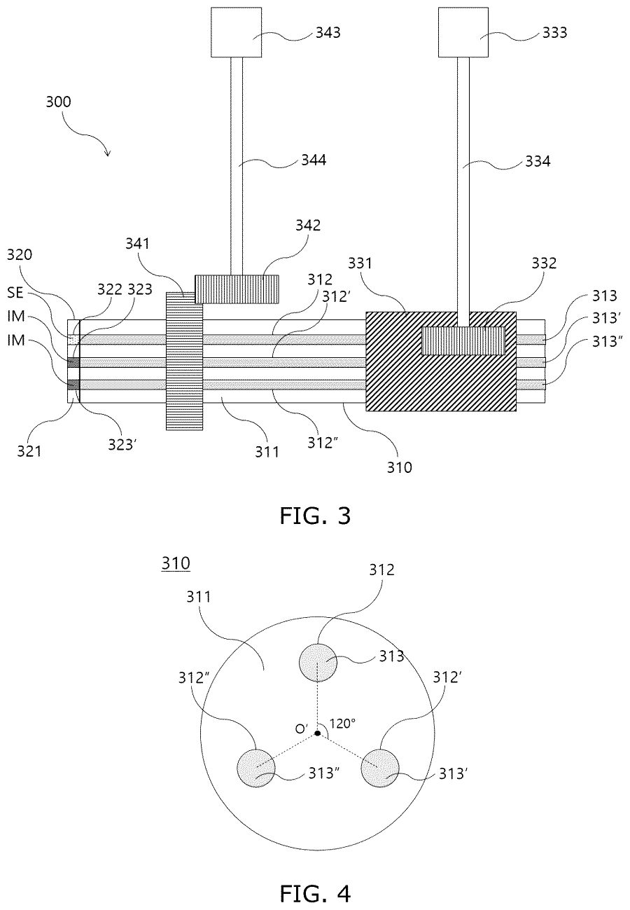

FIG. 3 is a view illustrating the reference electrode structure 300 of the test cell assembly according to an embodiment of the present disclosure. Referring to FIGS. 1 and 3, the connection part 320 of the reference electrode structure 300 according to an embodiment of the present disclosure may be inserted into the seating recess 111 and may have a cylindrical shape with a first surface in contact with the through-hole 112. In addition, the reference electrode part 310 may include a cylindrical fixing member 311 being in contact with a second surface of the connection part 320 and is rotatable about a lengthwise central axis thereof, two or more insertion passages 312, 312′, and 312″ formed through the fixing member 311 from a first end to a second end of the fixing member 311, and two or more reference electrodes 313, 313′, and 313″ inserted into the insertion passages 312, 312′, and 312″, respectively.

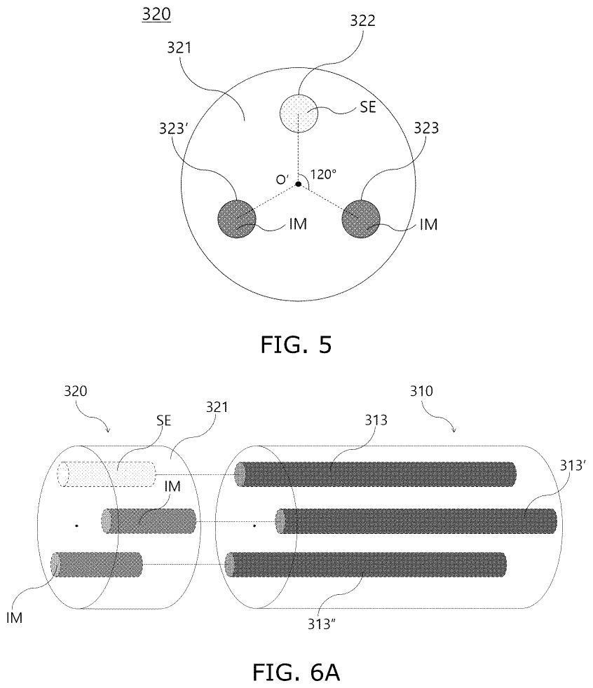

FIG. 5 is a sectional view illustrating the connection part 320 according to an embodiment of the present disclosure. Referring to FIG. 5, the connection part 320 may include a cylindrical plate 321, a connection hole 322 formed through the plate 321 from a first surface to a second surface of the plate 321, and insulating holes 323 and 323′ formed through the plate 321 from the first surface to the second surface of the plate 321 at predetermined distances from the connection hole 322. Here, the connection hole 322 may be filled with a solid electrolyte SE, and the insulating holes 323 and 323′ may be filled with an insulating material IM.

In FIG. 5, it is illustrated that the connection part 320 includes one connection hole 322 and two insulating holes 323 and 323′ and adjacent ones of the three connection hole 322 to insulating holes 323 and 323′ form an angle of 120° with respect to a center point O′, but this is merely an example. For example, the connection part 320 has to include one connection hole 322 and may include at least one or more insulating holes. Here, the connection hole 322 and the insulating holes may be arranged to form an angle of 360°/n (n being the total number of connection hole and insulating holes) with respect to the center point O′ on the plate 321.

In addition, the connection hole 322 may be configured to be in contact with the through-hole 112 of the body part 110. The through-hole 112 can be filled with a solid electrolyte, and the connection hole 322 can be also filled with a solid electrolyte. Therefore, as the connection hole 322 is positioned to be in contact with the through-hole 112, a movement passage for lithium ions may formed between the solid electrolyte part 220 and the connection hole 322.

The solid electrolyte filled in the connection hole 322 may be substantially the same as the solid electrolyte of the solid electrolyte part 220. The insulating material is not particularly limited as long as it does not undergo a special chemical reaction during an electrochemical signal acquisition process for the all-solid-state battery 200 and does not damage the reference electrodes 313, 313′, and 313″. For example, the insulating material may include polytetrafluoroethylene (PTFE), silicon (Si), nylon, or a combination thereof.

FIG. 4 is a sectional view illustrating the reference electrode part 310 according to an embodiment of the present disclosure. Referring to FIG. 4, the reference electrode part 310 may include two or more reference electrodes 313, 313′, and 313″. Here, the “reference electrode” may be defined as an electrode having a stable electrochemical potential that serves as a reference point for measuring the potential of one or more electrodes in an electrochemical cell.

As the test cell assembly according to an embodiment of the present disclosure includes the reference electrode 313, it not only acquires information about the potential difference between the cathode part 210 and the anode part 230, but also information about the potential differences between the cathode part 210 and the reference electrode part 310 and between the anode part 230 and the reference electrode part 310. That is, through the reference electrode part 310, in the process of evaluating the durability characteristics of the all-solid-state battery 200, it is possible to identify more specific deterioration factors by separately acquiring a signal of the cathode part 210 and a signal of the anode part 230.

In an embodiment, the reference electrodes 313, 313′, and 313″ may be formed by coating a noble metal on a wire, wherein the wire includes tungsten (W), aluminum (Al), nickel (Ni), stainless steel (SUS), or a combination thereof, wherein the noble metal includes gold (Au), silver (Ag), platinum (Pt), or a combination thereof. In addition, in the test cell assembly according to an embodiment of the present disclosure, because each reference electrode can be replaceable, it may be applied not only to materials resistant to contamination that were conventionally used as reference electrodes, but also to materials that have excellent performance as reference electrodes but are easily contaminated. In other words, as the wire of each reference electrode and the noble metal coated on the electrode, various materials other than those exemplified may be used without any particular restrictions.

The cylindrical fixing member 311 that is in contact with the second surface of the connection part 320 and is rotatable about the lengthwise central axis thereof may include an insulating material with low electrical conductivity. As the fixing member 311 includes the insulating material, it is possible to increase the accuracy of separately acquiring electrochemical signals of the cathode part 210 and the anode part 230 and to prevent a problem in which a short-circuit occurs due to current flowing between two or more reference electrodes included in the reference electrode part 310.

The two or more insertion passages 312, 312′, and 312″ formed through the fixing member 311 from the first end to the second end of the fixing member 311 may be formed to correspond to the number of reference electrodes 313, 313′, and 313″ to be included in an embodiment of the present disclosure. That is, the reference electrodes 313, 313′, and 313″ may be inserted into all the insertion passages 312, 312′, and 312″.

Referring to FIG. 4, the two or more insertion passages 312, 312′, and 312″ may be arranged to be rotationally symmetrical about the central axis. In FIG. 4, it is illustrated that the reference electrode part 310 includes three insertion passages 312, 312′, and 312″ and adjacent ones of the insertion passages 312, 312′, and 312″ form an angle of 120° with respect to a center point O′, but this is merely an example. Here, insertion passages 312, 312′, and 312″ may be arranged to form an angle of 360°/n (n being the total number of connection hole and insulating holes) with respect to the center point O′ on the fixing member 311. Here, because the reference electrodes 313, 313′, and 313″ are inserted into all the insertion passages 312, 312′, and 312″, the reference electrodes 313, 313′, and 313″ may also be arranged to be rotationally symmetrical about the central axis.

It can be preferable that the diameter of the cylindrical plate 321 and the diameter of the cylindrical fixing member 311 are the same. In addition, the total number of connection hole 322 and insulating holes included in the connection part 320 may be the same as the number of insertion passages 312, 312′, and 312″ or reference electrodes 313, 313′, and 313″ of the reference electrode part 310. Preferably, when the reference electrode part 310 is properly rotated, the positions of the connection hole 322 and the insulating holes of the connection part 320 and the reference electrodes 313, 313′, and 313″ of the reference electrode part 310 may correspond to each other.

In addition, the plate 321 may be made of a non-metallic material with wear resistance and chemical resistance so as to be chemically stable even when in contact with a solid electrolyte and to have the characteristic of not being worn even when the reference electrode structure 300 is repeatedly inserted. For example, the plate 321 may be made of polyetheretherketone (PEEK).

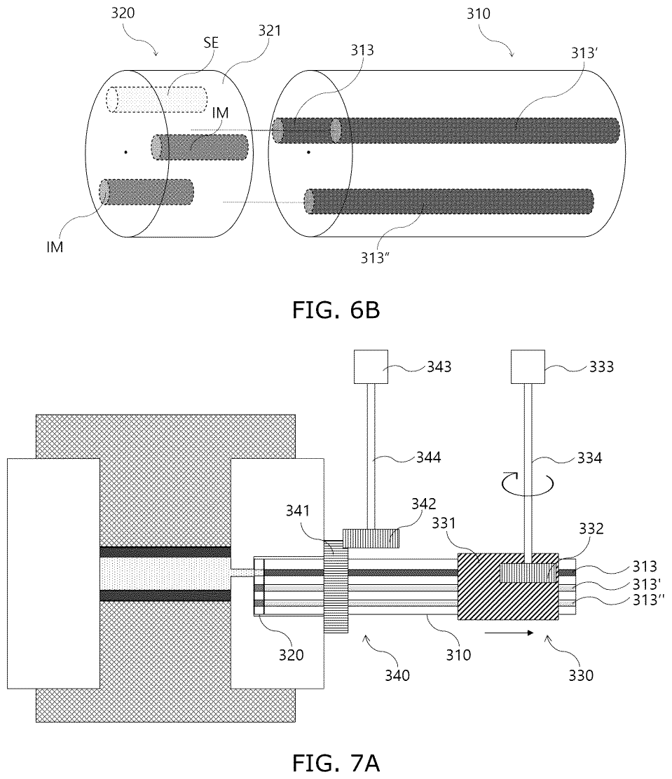

In an embodiment, the test cell assembly may be operated in a three-electrode mode in which a movement passage for lithium ions is formed between the all-solid-state battery 200 and the reference electrode structure 300, or a two-electrode mode in which a movement passage for lithium ions is not formed between the all-solid-state battery 200 and the reference electrode structure 300. This will be described in more detail with reference to FIGS. 6A and 6B.

FIG. 6A is a view illustrating the connection relationship between the connection part 320 and the reference electrode part 310 when the test cell assembly according to an embodiment of the present disclosure is operated in the three-electrode mode. Referring to FIG. 6A, the positions of all the connection hole 322 and insulating holes 323 and 323′ included in the connection part 320 and all the reference electrodes 313, 313′, and 313″ included in the reference electrode part 310 may correspond to each other.

As illustrated in FIG. 6A, the reference electrode 313 in contact with the connection hole 322 filled with the solid electrolyte SE can be connected to the solid electrolyte part 220, the through-hole 112 filled with the solid electrolyte, and the connection hole 322 filled with the solid electrolyte SE to form a passage for lithium ions. Therefore, the reference electrode 313 may be used as a reference electrode when measuring the potential of the cathode part 210 and the potential of the anode part 230 during operation of the test cell assembly. That is, the test cell assembly may be operated in the three-electrode mode when any one of the two or more reference electrodes 313, 313′, and 313″ is in contact with the connection hole 322.

FIG. 6B is a view illustrating the connection relationship between the connection part 320 and the reference electrode part 310 when the test cell assembly according to an embodiment of the present disclosure is operated in the two-electrode mode. Referring to FIG. 6B, the positions of all the connection hole 322 and insulating holes 323 and 323′ included in the connection part 320 and all the reference electrodes 313, 313′, and 313″ included in the reference electrode part 310 are misaligned and do not correspond to each other.

As such, when all the two or more reference electrodes 313, 313′, and 313″ are in contact with the plate 321 except for the connection hole 322 and the insulating holes 323 and 323′, a passage for lithium ions may not be formed between the all-solid-state battery 200 and the reference electrode structure 300. That is, the test cell assembly according to an embodiment of the present disclosure may be operated in the two-electrode mode.

In an embodiment, the linear movement part 330 may include a first moving member 331 provided along an outer peripheral surface of the fixing member 311, a second moving member 332 connected to the first moving member 331, and a first driving member 333 providing driving force to the second moving member 332. The first moving member 331 is connected to the fixing member 311 so as to be moved linearly together with the fixing member 311, and the second moving member 332 linearly moves the first moving member 331 in the lengthwise direction of the fixing member 311 by receiving driving force from the first driving member 333.

The first driving member 333 is not particularly limited as long as it can provide driving force to the second moving member 332, and may include, for example, manpower, a motor, or the like.

The first moving member 331 and the second moving member 332 are not particularly limited as long as they can convert the driving force provided from the first driving member 333 to a force that linearly moves the first moving member 331. For example, the first moving member 331 may include a worm gear provided with at least one thread, and the second moving member 332 may include a worm wheel provided with two or more teeth to engage with the thread. Alternatively, the first moving member 331 may include a rack provided with at least one thread, and the second moving member 332 may include a pinion gear provided with two or more teeth to engage with the thread.

In addition, the linear movement part 330 may include a rod-shaped first shaft 334. The first shaft 334 can have a first end connected to the second moving member 332 and a second end connected to the first driving member 333 and can transmit the driving force of the first driving member 333 to the second moving member 332.

In an embodiment, the rotational movement part 340 may include a first rotating member 341 provided along an outer peripheral surface of the fixing member 311, a second rotating member 342 connected to the first rotating member 341, and a second driving member 343 providing driving force to the second rotating member 342. The first rotating member 341 can be connected to the fixing member 311 so as to be rotated together with the fixing member 311, and the second rotating member 342 can rotate the first rotating member 341 about the central axis by receiving driving force from the second driving member 343.

The second driving member 343 is not particularly limited as long as it can provide driving force to the second rotating member 342, and may include, for example, manpower, a motor, or the like.

The first rotating member 341 and the second rotating member 342 are not particularly limited as long as they can convert the driving force provided from the second driving member 343 to a force that rotates the first rotating member 341 about the central axis. For example, the first rotating member 341 may include a first bevel gear, the second rotating member 342 may include a second bevel gear, and the first bevel gear and the second bevel gear may be connected to mesh with each other. Here, the “bevel gear” can be a cone-shaped gear that transmits power between two intersecting axes, and any gears commonly used to change the direction of rotational force may be used.

In an embodiment, the rotational movement part 340 may include a rod-shaped second shaft 344.

The second shaft 344 can have a first end connected to the second rotating member 342 and a second end connected to the second driving member 343 and can transmit the driving force of the second driving member 343 to the second rotating member 342.

In an embodiment, when a reference electrode used in the test cell assembly is contaminated and deteriorated and needs to be replaced, the reference electrode may be replaced without disassembling the all-solid-state battery 200, which is an advantage.

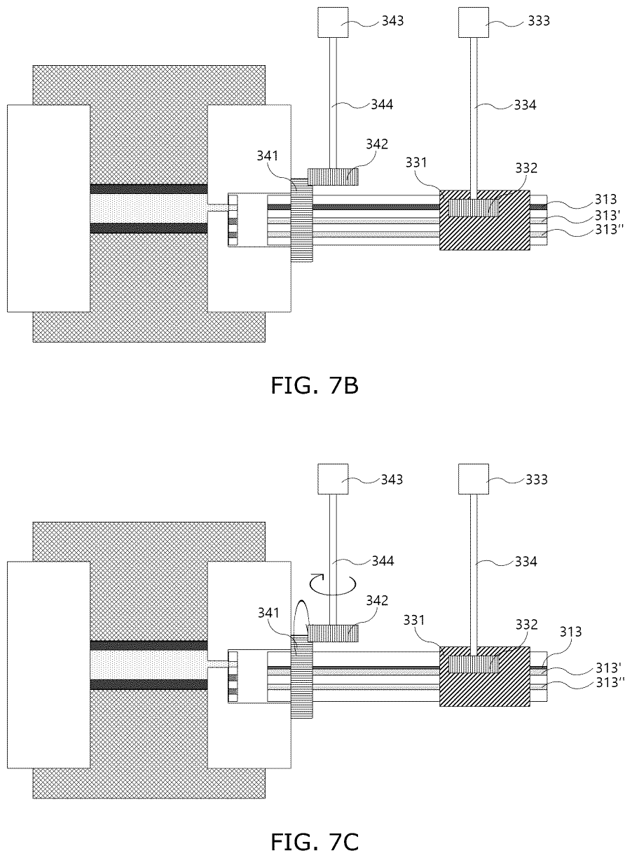

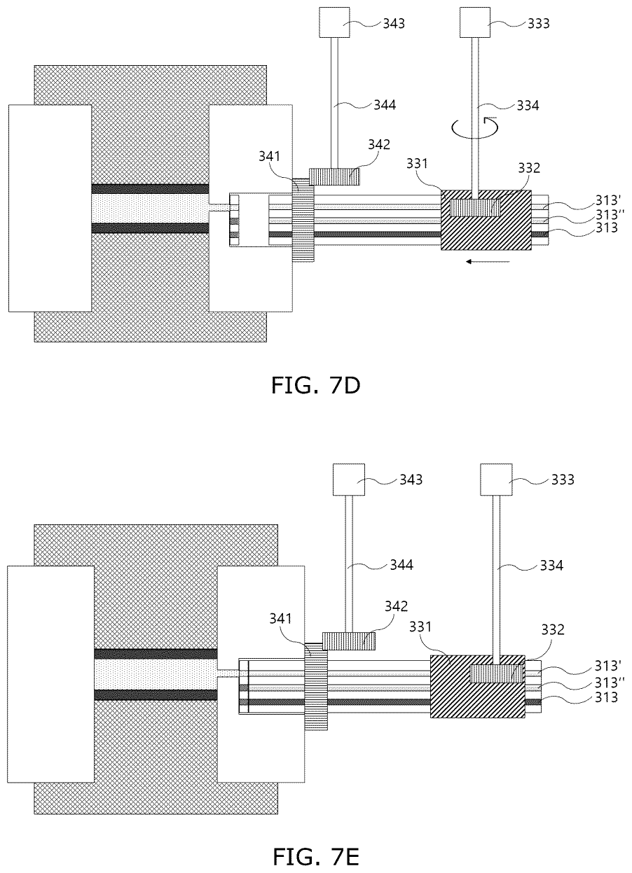

Hereinbelow, an example process of replacing the reference electrode will be described with reference to FIGS. 7A to 7E.

Referring to FIG. 7A, the first driving member 333 may provide rotational force to the second moving member 332 through the first shaft 334. As the second moving member 332 is rotated clockwise, the first moving member 331 connected to the second moving member 332 may be moved linearly to the right. Here, the first moving member 331 may be, for example, a worm gear, and the second moving member 332 may be, for example, a worm wheel.

FIG. 7B is a view illustrating that as the first moving member 331 is moved to the right, the reference electrode part 310 is also moved to the right. Due to the rightward movement of the reference electrode part 310, the contact between the second surface of the connection part 320 and the first end of the fixing member 311 may be disconnected.

Referring to FIG. 7C, the second driving member 343 may provide rotational force to the second rotating member 342 through the second shaft 344. As the second rotating member 342 is rotated clockwise, the first rotating member 341 connected to the second rotating member 342 may be rotated clockwise about the central axis of the reference electrode part 310. Here, the first rotating member 341 may be, for example, a first bevel gear, and the second rotating member 342 may be, for example, a second bevel gear meshing with the first bevel gear.

FIG. 7D is a view illustrating that as the first rotating member 341 is rotated clockwise about the central axis of the reference electrode part 310, the relative positions of the two or more reference electrodes 313, 313′, and 313″ are changed. Referring to FIG. 7d, after changing the positions of the reference electrodes through the above process, the first driving member 333 may be rotated in the direction opposite to that illustrated in FIG. 7A. As the second moving member 332 is rotated counterclockwise, the first moving member 331 connected to the second moving member 332 may be moved linearly to the left.

FIG. 7E is a view illustrating that as the first moving member 331 is moved to the left, the reference electrode part 310 is also moved to the left. Due to the leftward movement of the reference electrode part 310, the second surface of the connection part 320 and the replaced reference electrode 313′ may come into contact with each other.

The test cell assembly according to an embodiment of the present disclosure can replace the contaminated or deteriorated reference electrode 313 without disassembling the all-solid-state battery 200 through the process illustrated in FIGS. 7A to 7E.

In addition, the test cell assembly can be switched from the three-electrode mode to the two-electrode mode, or from the two-electrode mode to the three-electrode mode, and switching between the electrode modes can be performed without disassembling the all-solid-state battery 200.

Switching between the electrode modes may be substantially the same as the reference electrode replacement process illustrated in FIGS. 7A to 7E except for a rotation angle of the reference electrode part 310. That is, as illustrated in FIG. 6A, when the reference electrode part 310 is rotated so that the connection hole 322 of the connection part 320 and the reference electrode exist in corresponding positions, this may mean replacement of the reference electrode. In addition, as illustrated in FIG. 6B, when the reference electrode part 310 is rotated so that the connection hole 322 of the connection part 320 and the reference electrode exist in positions that do not correspond to each other, this may mean a transition from the three-electrode mode to the two-electrode mode.

As such, replacement of the reference electrode or switching between the electrode modes may vary depending on the rotation angle of the reference electrode part 310. Therefore, the test cell assembly according to an embodiment of the present disclosure may include a configuration to more easily control the rotation angle.

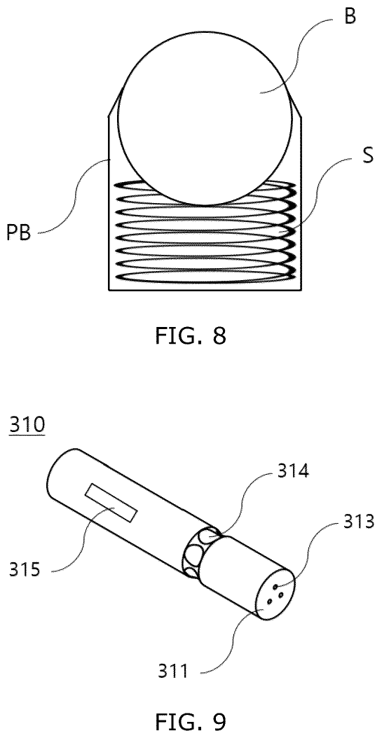

FIG. 8 is a view illustrating a ball plunger according to an embodiment of the present disclosure. The ball plunger can be used to fix or position an object, and may include a plunger body PB having an internal region of a predetermined volume and having an opening open in one direction, a spring S located in the internal region and providing elastic force, and a plunger ball B located in the opening of the plunger body PB and movable in the vertical direction by the spring S.

When the plunger ball B enters the inside of the plunger body PB under compressive force and meets an insertion concave portion recessed to a predetermined depth to allow the plunger ball B to be inserted therein, a portion of the plunger ball B may come out of the plunger body PB and be engaged with the insertion concave portion by restoring force of the spring S.

When a force exceeding the elastic force of the spring S of the ball plunger is applied while the ball plunger and the insertion concave portion are coupled to each other, the ball plunger and the insertion concave portion may be separated from each other.

In an embodiment, the linear movement part 330 may include at least one first ball plunger 335 formed on an inner peripheral surface of the first moving member 331, and the reference electrode part 310 may include two or more first insertion concave portions 314 recessed and spaced apart from each other at a predetermined angle along the circumference of the outer peripheral surface of the fixing member 311.

In an embodiment, the rotational movement part 340 may include at least one second ball plunger 345 formed on an inner peripheral surface of the first rotating member 341, and the reference electrode part 310 may include a second insertion concave portion 315 recessed on the outer peripheral surface of the fixing member 311 to extend along the lengthwise direction thereof.

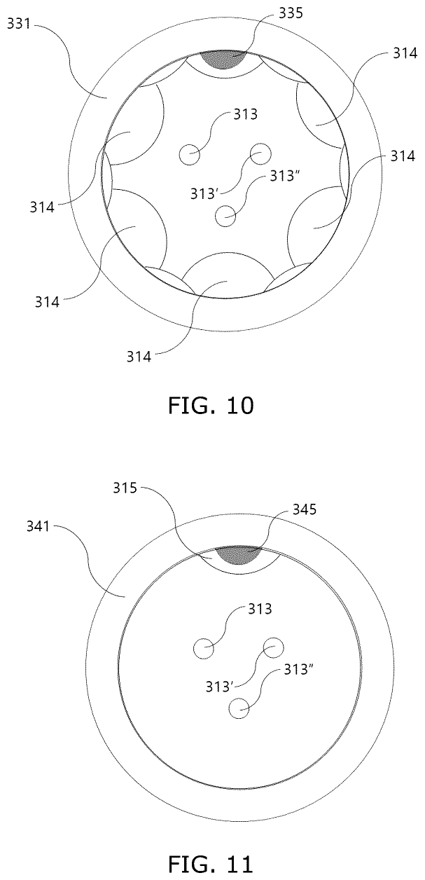

FIG. 9 is a view illustrating the reference electrode part 310 in which the first insertion concave portions 314 and the second insertion concave portion 315 are formed according to an embodiment of the present disclosure. FIG. 10 is a view illustrating engagement between the first ball plunger 335 and one of the first insertion concave portions 314 according to an embodiment of the present disclosure. FIG. 11 is a view illustrating engagement between the second ball plunger 345 and the second insertion concave portion 315 according to an embodiment of the present disclosure.

According to an embodiment of the present disclosure, as the reference electrode part 310 includes the two or more first insertion concave portions 314 that are recessed and spaced at a predetermined angle along the circumference of the outer peripheral surface of the fixing member 311 and the first ball plunger 335 of the linear movement part 330 is engaged with at least one of the first insertion concave portions 314, the rotation of the reference electrode part 310 may be guided to be rotated in units of an angle at which the first insertion concave portions 314 are formed.

In addition, as the reference electrode part 310 includes the second insertion concave portion 315 that is recessed on the outer peripheral surface of the fixing member 311 and extends along the lengthwise direction thereof and the second ball plunger 345 is engaged with the second insertion concave portion 315, the reference electrode part 310 may be guided to be linearly moved within an extended length of the second insertion concave portion 315.

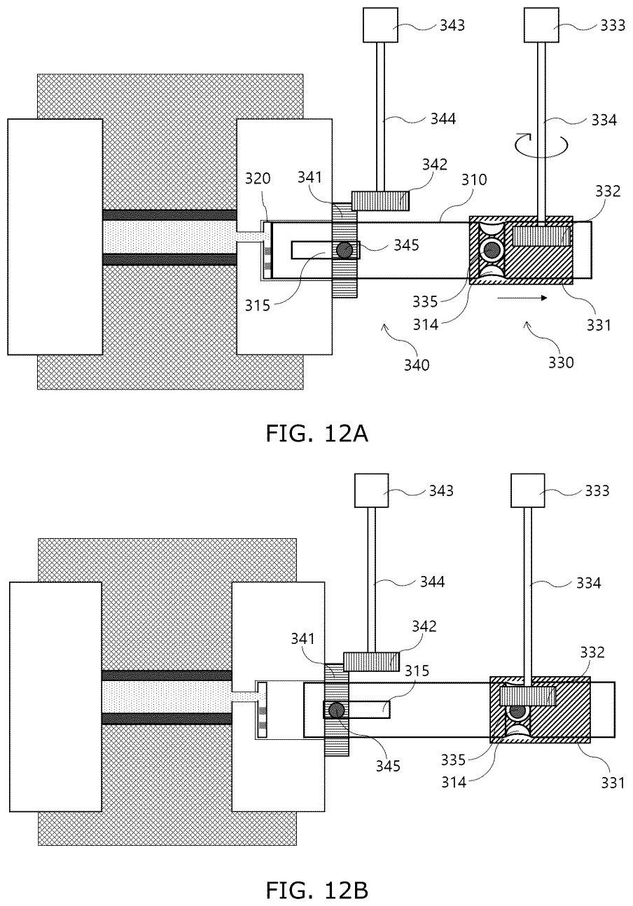

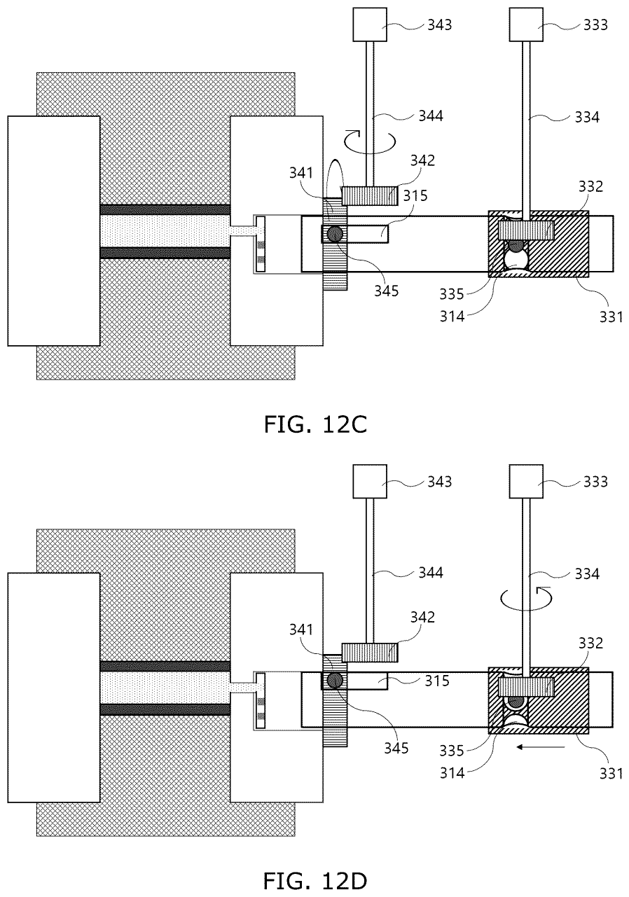

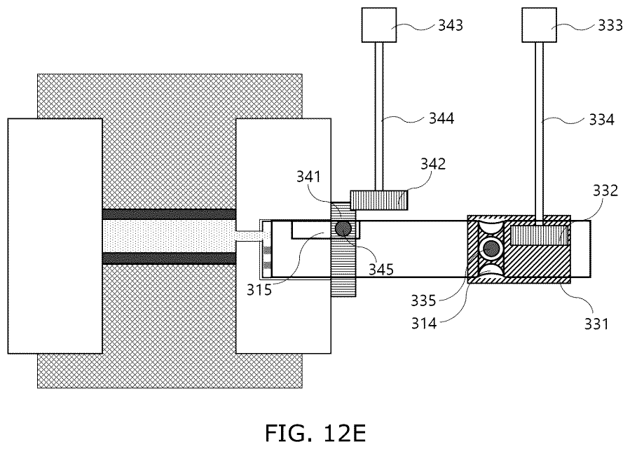

Hereinbelow, the method of operating the first ball plunger 335 and the first insertion concave portion 314, and the second ball plunger 345 and the second insertion concave portion 315 in the process of replacing the reference electrode will be described with reference to FIGS. 12A to 12E. In FIGS. 12A to 12E, the reference electrodes are not shown to simplify the drawings.

Referring to FIG. 12A, the first driving member 333 may provide rotational force to the second moving member 332 through the first shaft 334. As the second moving member 332 is rotated clockwise, the first moving member 331 connected to the second moving member 332 may be moved linearly to the right.

FIG. 12B is a view illustrating that as the first moving member 331 is moved to the right, the reference electrode part 310 is also moved to the right. Here, the movement of the reference electrode part 310 is limited to a predetermined length range due to the second ball plunger 345 inserted into the second insertion concave portion 315.

Referring to FIG. 12C, the second driving member 343 may provide rotational force to the second rotating member 342 through the second shaft 344. As the second rotating member 342 is rotated clockwise, the first rotating member 341 connected to the second rotating member 342 may be rotated clockwise about the central axis of the reference electrode part 310. In this process, the first ball plunger 335 is separated from a first insertion concave portion 314 with which it is previously engaged by receiving a force greater than elastic force of a first spring and is moved to another adjacent first insertion concave portion 314.

FIG. 12D is a view illustrating that the first rotating member 341 is rotated clockwise about the central axis of the reference electrode part 310. The first ball plunger 335 is separates from the first insertion concave portion 314 with which it is engaged in FIGS. 12A and 12B and engaged with another adjacent first insertion concave portion 314. As illustrated in FIG. 10, when six first insertion concave portions 314 are formed on the outer peripheral surface of the fixing member 311, the reference electrode part 310 may be rotated in units of 60°.

Referring to FIG. 12D, after changing the positions of the reference electrodes through the above process, the first driving member 333 may be rotated in the direction opposite to that illustrated in FIG. 12A. As the second moving member 332 is rotated counterclockwise, the first moving member 331 connected to the second moving member 332 may be moved linearly to the left.

FIG. 12E is a view illustrating that as the first moving member 331 is moved to the left, the reference electrode part 310 is also moved to the left. Due to the leftward movement of the reference electrode part 310, the second surface of the connection part 320 and the replaced reference electrode 313′ may come into contact with each other.

The test cell assembly according to an embodiment of the present disclosure can replace the contaminated or deteriorated reference electrode without disassembling the all-solid-state battery 200 through the process illustrated in FIGS. 12A to 12E. In addition, the test cell assembly can be switched from the three-electrode mode to the two-electrode mode, or from the two-electrode mode to the three-electrode mode, and switching between the electrode modes can be performed without disassembling the all-solid-state battery 200.

In addition, by including the first ball plunger 335, the first insertion concave portions 314, the second ball plunger 345, and the second insertion concave portion 315, the rotation angle and moving distance of the reference electrode part 310 can be more easily controlled and indexed.

A first plunger body of the first ball plunger 335 may be formed integrally with the inner peripheral surface of the first moving member 331. In addition, a second plunger body of the second ball plunger 345 may be formed integrally with the inner peripheral surface of the first rotating member 341.

Because the first ball plunger 335 and the second ball plunger 345 can be substantially the same as the ball plunger, detailed descriptions thereof will be omitted.

Referring to FIG. 1, according to an embodiment, the test cell assembly may further include a housing 400 having a predetermined empty space to accommodate the frame 100, the all-solid-state battery 200, and the reference electrode structure 300. The process of separately acquiring the electrochemical signals of the cathode part 210 and the anode part 230 using the test cell assembly may be performed in a vacuum or low pressure state. The housing 400 may help lower the pressure more easily in the process of separately acquiring the electrochemical signals of the cathode part 210 and the anode part 230.

In addition, according to an embodiment, the test cell assembly may include a connection conducting wire connected to a power source. The connection wire may include: a cathode conducting wire 510 connected to the cathode part 210; an anode conducting wire 520 connected to the anode part 230; and reference electrode conducting wires 530, 530′, and 530″ connected to the reference electrodes. At this time, the reference electrode conducting wires 530, 530′, and 530″ may be electrically connected to all the two or more reference electrodes.

While the present disclosure has been described with reference to various example embodiments thereof, it can be understood by those skilled in the art that various changes in form and details may be made therein without departing from the spirit and scope of the present disclosure as defined by the appended claims and their equivalents.

What is claimed is:

1. A test cell assembly, comprising:
a frame having an internal space of a first volume;
an all-solid-state battery accommodated in the internal space of the frame; and
a reference electrode structure provided on an outer lateral surface of the frame, wherein the reference electrode structure comprises:
a reference electrode part configured to acquire electrochemical signals of the all-solid-state battery;
a connection part fixed to the outer lateral surface of the frame and being in contact with the reference electrode part;
a linear movement part configured to linearly move the reference electrode part; and
a rotational movement part configured to rotate the reference electrode part.

2. The test cell assembly of claim 1, wherein the frame comprises:
a hollow body part having open upper and lower sides and having the internal space;
an upper pressurizing part fitted to the upper side of the body part and pressurizing an upper portion of the all-solid-state battery in a contact manner; and
a lower pressurizing part fitted to the lower side of the body part and pressurizing a lower portion of the all-solid-state battery in a contact manner.

3. The test cell assembly of claim 2, wherein the body part comprises:
a seating recess recessed to a first depth from an outer lateral surface of the body part; and
a through-hole formed through an inner surface of the body part to communicate the internal space and the seating recess with each other.

4. The test cell assembly of claim 3, wherein the body part further comprises a filling member filled in the through-hole, wherein the filling member comprises a solid electrolyte, and wherein the filling member forms a movement passage for lithium ions between the all-solid-state battery and the reference electrode structure.

5. The test cell assembly of claim 3, wherein the connection part is inserted into the seating recess and has a cylindrical shape with a first surface in contact with the through-hole, and wherein the reference electrode part comprises:
a cylindrical fixing member configured to be in contact with a second surface of the connection part and rotatable about a lengthwise central axis thereof;
two or more insertion passages formed through the fixing member from a first end to a second end thereof; and
two or more reference electrodes respectively inserted into the two or more insertion passages.

6. The test cell assembly of claim 5, wherein the connection part further comprises:
a cylindrical plate;
a connection hole formed through the plate from a first surface to a second surface thereof; and
an insulating hole formed through the plate from the first surface to the second surface thereof at a position spaced apart from the connection hole by a first distance, wherein the connection hole is filled with a solid electrolyte, and wherein the insulating hole is filled with an insulating material.

7. The test cell assembly of claim 5, wherein the two or more insertion passages are arranged to be rotationally symmetrical about the central axis.

8. The test cell assembly of claim 5, wherein the reference electrodes are formed by coating a noble metal on a wire;
wherein the wire comprising one selected from the group consisting of tungsten (W), aluminum (Al), nickel (Ni), stainless steel (SUS), and a combination thereof; and
wherein the noble metal comprising one selected from the group consisting of gold (Au), silver (Ag), platinum (Pt), and a combination thereof.

9. The test cell assembly of claim 6, wherein the test cell assembly is configured to be operated in a three-electrode mode in which any one of the two or more reference electrodes is in contact with the connection hole; and
wherein the test cell assembly is configured to be operated in a two-electrode mode in which all the two or more reference electrodes are in contact with the plate and not aligned with the connection hole and the insulating hole.

10. The test cell assembly of claim 1, wherein the test cell assembly is configured to be operated in a three-electrode mode in which a movement passage for lithium ions is formed between the all-solid-state battery and the reference electrode structure; and
wherein the test cell assembly is configured to be operated in a two-electrode mode in which a movement passage for lithium ions is not formed between the all-solid-state battery and the reference electrode structure.

11. The test cell assembly of claim 10, wherein the test cell assembly is configured to be switched from the three-electrode mode to the two-electrode mode or from the two-electrode mode to the three-electrode mode, such that switching between the three-electrode mode and the two-electrode mode is performed without disassembling the all-solid-state battery.

12. The test cell assembly of claim 5, wherein the linear movement part comprises:
a first moving member provided along an outer peripheral surface of the fixing member;
a second moving member connected to the first moving member; and
a first driving member configured to provide a driving force to the second moving member, wherein the first moving member is connected to the fixing member to be moved linearly together with the fixing member, and wherein the second moving member is configured to linearly move the first moving member in a lengthwise direction of the fixing member by receiving the driving force from the first driving member.

13. The test cell assembly of claim 12, wherein the linear movement part comprises a rod-shaped first shaft, wherein the first shaft has a first end connected to the second moving member and a second end connected to the first driving member, such that the first shaft is configured to transmit the driving force of the first driving member to the second moving member.

14. The test cell assembly of claim 12, wherein the first moving member comprises a worm gear provided with at least one thread; and
wherein the second moving member comprises a worm wheel provided with two or more teeth to be engaged with the thread.

15. The test cell assembly of claim 12, wherein the linear movement part comprises at least one first ball plunger formed on an inner peripheral surface of the first moving member, wherein the reference electrode part comprises two or more first insertion concave portions recessed and spaced apart at a selected angle along a circumference of the outer peripheral surface of the fixing member; and
wherein the first ball plunger comprises:
a first plunger body having an internal region of a second volume and having an opening open in one direction;
a first spring located in the internal region; and
a first plunger ball located in the opening of the first plunger body and movable in a vertical direction by the first spring, wherein the first plunger ball is configured to be inserted into the first insertion concave portion.

16. The test cell assembly of claim 5, wherein the rotational movement part comprises:
a first rotating member provided along an outer peripheral surface of the fixing member;
a second rotating member connected to the first rotating member; and
a second driving member configured to provide a driving force to the second rotating member, wherein the first rotating member is connected to the fixing member to be rotated together with the fixing member, and wherein the second rotating member is configured to rotate the first rotating member about the central axis by receiving the driving force from the second driving member.

17. The test cell assembly of claim 16, wherein the first rotating member comprises a first bevel gear;
wherein the second rotating member comprises a second bevel gear; and
wherein the first bevel gear and the second bevel gear are connected to mesh with each other.

18. The test cell assembly of claim 16, wherein the rotational movement part comprises a rod-shaped second shaft, and wherein the second shaft has a first end connected to the second rotating member and a second end connected to the second driving member, such that the second shaft is configured to transmit the driving force of the second driving member to the second rotating member.

19. The test cell assembly of claim 16, wherein the rotational movement part comprises at least one second ball plunger formed on an inner peripheral surface of the first rotating member;
wherein the reference electrode part comprises a second insertion concave portion recessed on the outer peripheral surface of the fixing member to extend along a lengthwise direction thereof; and
wherein the second ball plunger comprises:
a second plunger body having an internal region of a second volume and having an opening open in one direction;
a second spring located in the internal region; and
a second plunger ball located in the opening of the second plunger body and movable in a vertical direction by the second spring, wherein the second plunger ball is inserted into the second insertion concave portion.
